(19) United States
(12) Patent Application Publication
(10) Pub. No.: US 2008/0022680 A1
(43) Pub. Date: Jan. 31, 2008

(54) Apparatus and method for increasing the hydrogen content of recirculated exhaust gas in fuel injected engines

(76) Inventors: Jess W. Gingrich, San Antonio, TX (US); Terrence F. Alger, San Antonio, TX (US)

Correspondence Address: Ted D. Lee;Gunn & Lee, P.C., Suite 1500, 700 N. St. Mary's St., San Antonio, TX, 78205, US

(21) Appl. No.: 11/493,451

(22) Filed: Jul. 26, 2006

(51) Int. Cl. F02B 33/44; F02D 23/00

(52) U.S. Cl. 60/605.2; 60/600

(57) ABSTRACT

A water-gas shift catalyst in an exhaust gas recirculation system of either a naturally-aspirated or forced induction fuel-injected internal combustion engine uses a water-gas shift reaction to increase the amount of hydrogen in recirculated exhaust gas.

### BACKGROUND OF THE INVENTION

1. Technical Field

This invention relates generally to an apparatus and method for increasing the amount of hydrogen in the recirculated exhaust gas of fuel-injected engines, and more particularly to such an apparatus and method in which at least a portion of the recirculated exhaust gas is passed through a water-gas shift catalyst.

2. Background Art

With continuing federal, state and consumer demands for engines to achieve higher efficiency and lower emissions, manufacturers are continually developing control strategies to improve engine performance. One such proven technique is hydrogen-enriched fuel, for example, Hythane and Syngas. Increased levels of hydrogen (H₂) enable stable engine operation under dilute air/fuel ratio conditions and accelerate the combustion event relative to the base fuel. Engine-knock tolerance also increases with accelerated combustion, allowing the engine to operate at higher compression ratios, resulting in higher efficiencies.

U.S. Pat. No. 5,339,634 granted Aug. 23, 1994 to Nigel F. Gale, et al. and assigned to the assignee of the present invention, describes a system and process for enhancing the hydrogen content of recirculated exhaust gas in carburetted reciprocating and gas turbine engines. Carburetted engines require a carburetor instead of fuel injectors. In the Gale, et al. patent, separate carburetors are required to vaporize fuel and mix it with air prior to the introduction of specifically-formed air/fuel mixtures into respective combustion chambers of the engine. One of the carburetors is controlled to provide a rich air/fuel mixture which, after combustion in one or more dedicated combustion chambers, is directed through a water-gas shift catalyst to provide a hydrogen-enriched exhaust gas. The hydrogen-enriched exhaust gas is mixed with air and fuel in a second carburetor and inducted into the remaining combustion chambers of the engine. The described arrangement is not applicable to fuel-injected engines which do not pre-mix air and fuel prior to introduction into the combustion chambers of an engine.

U.S. Pat. No. 6,742,307 B2 granted Jun. 1, 2004 to Bowie G. Keefer, et al. for FUEL COMPOSITION MODICATION FOR INTERNAL COMBUSTION ENGINES describes a process that uses a rotary pressure swing adsorption apparatus to reform exhaust gas produced by an engine. The primary function of the process is to provide oxygen/nitrogen enrichment of a fresh charge introduced into one or more combustion chambers of the engine. In a sub-process, hydrogen is produced as a fuel for use in a fuel cell. Any excess hydrogen can be routed into the engine intake manifold to aid lean burn combustion.

Fuel reforming is also used to increase the hydrogen content of the reformed fuel. Fuel reforming, as described in U.S. Pat. No. 6,823,852 D2, granted Nov. 30, 2004, to R. Kirk Collier, Jr., for a LOW-EMISSION INTERNAL COMBUSTION ENGINE is used to supply H₂O and heat to a reactor for the purpose of reforming fuel into lighter components. However, fuel reforming is a highly exothermic process that causes a decrease in net thermal efficiency when compared with an engine system that does not require fuel reforming to produce hydrogen.

The present invention is directed to overcoming the problems associated with hydrogen enriched combustion in fuel-injected engines. It is desirable to provide a hydrogen-enriched intake air/recirculated exhaust gas charge to the combustion chambers of fuel injected engines. It is desirable to have a hydrogen enrichment process that can be incorporated into both naturally aspirated and forced-induction fuel-injected engine control strategies that use exhaust gas recirculation (EGR). Moreover, it is desirable to have a process that advantageously uses the low minimum ignition energy and wide flammability range of hydrogen to increase the ignitability of very dilute recirculated exhaust gas/air mixtures into which fuel is injected immediately prior to combustion, while simultaneously increasing engine exhaust EGR tolerance.

### SUMMARY OF THE INVENTION

In accordance with one aspect of the present invention, an apparatus for increasing the amount of hydrogen in the recirculated exhaust gas of an engine having a plurality of combustion chambers, an intake manifold, and an exhaust manifold in fluid communication with at least one of the combustion chambers, includes a fuel injection system, and an exhaust gas recirculation (EGR) system. The EGR system has an inlet in fluid communication with the exhaust manifold and an outlet in fluid communication with the intake manifold. The apparatus also includes a water-gas shift catalyst disposed in the EGR system and an exhaust gas recirculation flow control valve positioned to control exhaust gas flow through the EGR system. The inlet of the EGR flow control valve is in fluid communication with the exhaust manifold of the engine and the outlet of the EGR valve is in fluid communication with the inlet of the water-gas shift catalyst.

Other features of the apparatus for increasing the amount of hydrogen in the recirculated exhaust gas of a fuel-injected engine in accordance with the present invention, include the apparatus having a compressor with an inlet in fluid communication with a source of ambient air, and in one embodiment also in direct fluid communication with the outlet of the water-gas shift catalyst.

Another feature of the present invention includes the apparatus for increasing the amount of hydrogen in the recirculated exhaust gas of a fuel-injected engine having a heat exchanger with an inlet in fluid communication with an outlet of the compressor, and, in one embodiment, is also in direct fluid communication with the outlet of the water-gas shift catalyst.

In accordance with another aspect of the present invention, a method for increasing the amount of hydrogen in the recirculated exhaust gas of a fuel-injected engine that has a plurality of combustion chambers, an intake manifold and an exhaust manifold, includes providing an exhaust gas recirculation system that has an inlet in fluid communication with the exhaust manifold and an outlet in fluid communication with the intake manifold. The method further includes disposing a water-gas shift catalyst in the exhaust gas recirculation system. A mixture of recirculated exhaust gas and ambient air is inducted into the combustion chambers. Fuel is controllably injected, burned and discharged into the exhaust manifold. A portion of the discharged exhaust gas is controllably circulated through the water-gas shift catalyst wherein a hydrogen-enriched exhaust gas is formed and subsequently directed into the intake manifold of the engine.

The method for increasing the amount of hydrogen in the recirculated exhaust gas of a fuel-injected engine, in accordance with the present invention, also includes the engine having a first exhaust manifold in communication with at least one of the combustion chambers and a second exhaust manifold in fluid communication with other combustion chambers. The inlet of the exhaust gas recirculation system is in fluid communication with only the first exhaust manifold. The method further includes controllably recirculating at least a portion of the exhaust gas from the first exhaust manifold, through the exhaust gas recirculation system, the water-gas shift catalyst, and to the intake manifold.

### BRIEF DESCRIPTION OF THE DRAWINGS

A more complete understanding of the apparatus and method for increasing the amount of hydrogen in the recirculated exhaust gas of a fuel-injected engine may be had by reference to the following detailed description when taken in conjunction with the accompanying drawings, wherein:

FIG. 1 is a three-dimensional view of a representative forced induction fuel-injected engine adapted for increasing the amount of hydrogen in recirculated exhaust gas, in accordance with the present invention;

FIG. 2 is a simplified schematic diagram of the fuel-injected engine illustrated in FIG. 1;

FIG. 3 is a simplified schematic diagram of an alternate embodiment of a forced-induction fuel-injected engine adapted for increasing the amount of hydrogen in recirculated exhaust gas of an engine, in accordance with the present invention; and,

FIG. 4 is a simplified schematic diagram of a naturally aspirated fuel-injected engine adapted for increasing the amount of hydrogen in the recirculated exhaust gas of an engine in accordance with the present invention.

### DETAILED DESCRIPTION OF THE INVENTION

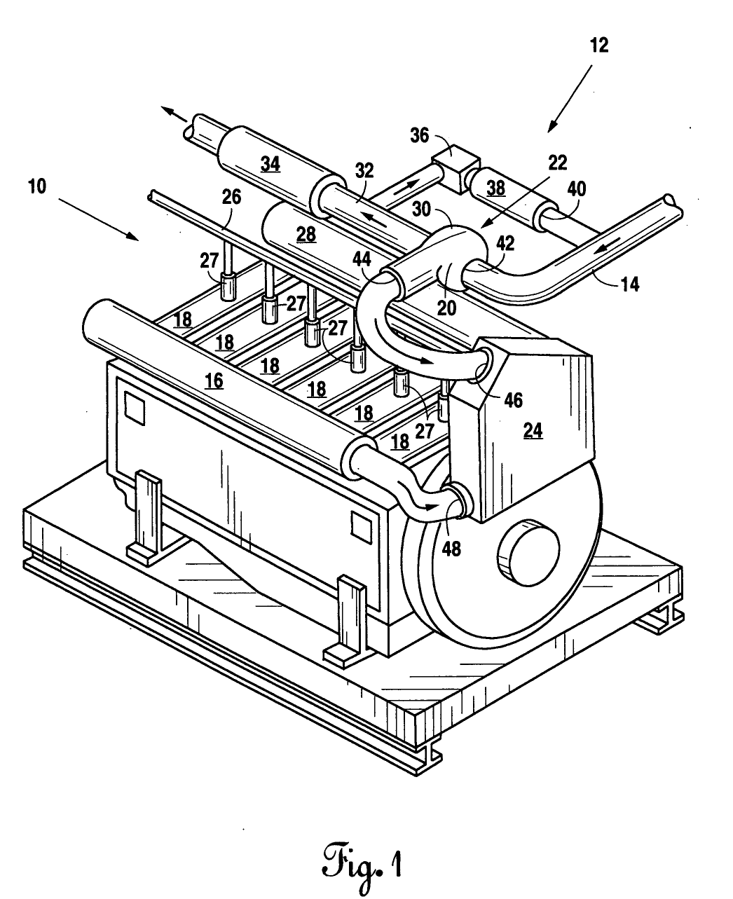

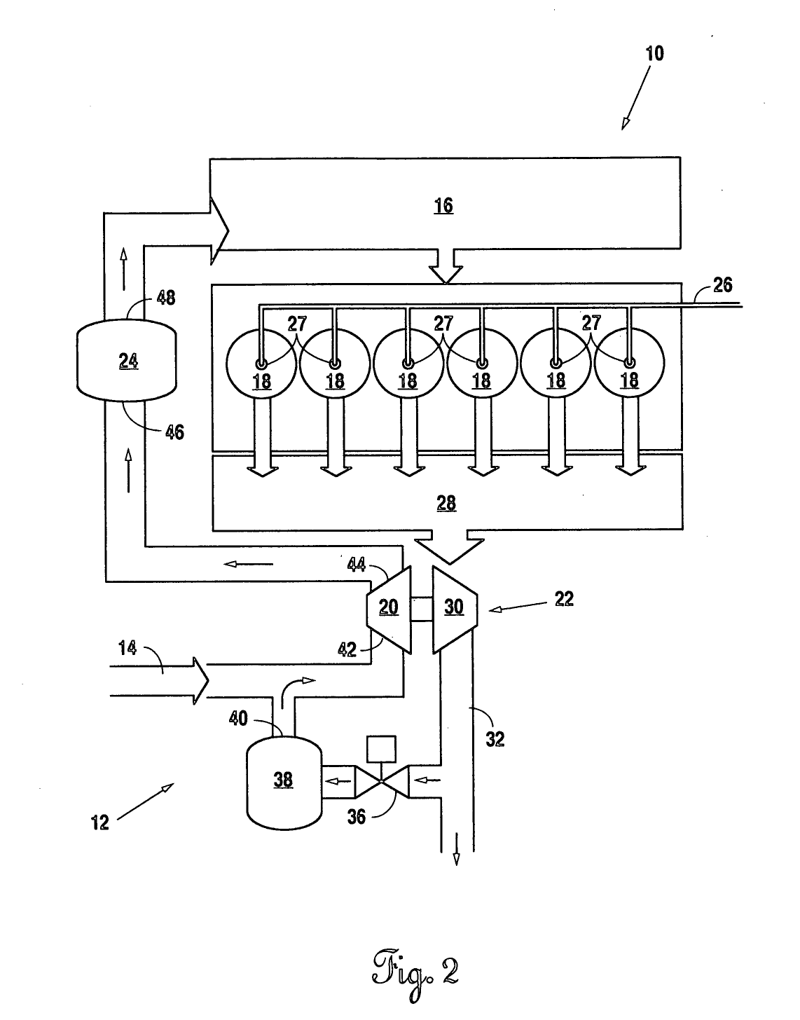

A first preferred embodiment of the present invention is illustrated in FIGS. 1 and 2 with reference to a representative fuel-injected engine internal combustion engine generally indicated by the reference numeral 10. “Fuel-injected” as used in the following discussion and claims means an engine that uses no carburetor but sprays fuel either directly into the combustion chambers of the engine or into the intake manifold just ahead of the combustion chamber. Generally, fuel injected engines use electronic sensing devices to control fuel injectors which inject closely controlled amounts of fuel. For purposes of the following discussion, the engine 10 may be either a naturally aspirated or forced induction fuel-injected engine fueled with gasoline, natural gas, or other spark-ignitable hydrocarbon fuel, or a diesel engine fueled with diesel, bio-diesel, or other compression-ignitable fuel. Naturally aspirated engines take in air at normal pressure, i.e., they are not turbocharged or supercharged as is the case with forced induction engines.

In the first-described embodiment of the present invention, the engine 10 has a high pressure exhaust gas recirculation (EGR) system, generally represented by the reference numeral 12. Importantly, hydrogen (H₂) is produced in the EGR system 12 by a water-gas shift reaction. The water-gas shift is a slightly exothermic reaction in which water vapor (H₂O) and carbon monoxide (CO) produce hydrogen (H₂) and carbon dioxide (CO₂). The water-gas shift reaction is represented by the following reaction formula:

CO+H₂O→CO₂+H₂

In the present invention, the water-gas shift reaction is accelerated with a catalyst, discussed below in greater detail, and can be incorporated into current engine control strategies using exhaust gas recirculation. Importantly, in the present invention, as exhaust gas recirculation levels increase, the amount of H₂ will increase proportionately. Hydrogen has low minimum ignition energy and a wide flammability range. The combination of low minimum ignition energy and wide flammability increases the ignitability of very dilute mixtures, thereby increasing the engine's tolerance for relative amounts of recirculated exhaust gas. Higher levels of exhaust gas recirculation will increase part load brake efficiency due to a decrease in pumping losses. Furthermore, it is known that high EGR levels reduce NO_{X} emissions by a significant amount, for example, up to ten percent (10%) of the base engine NO_{X} emission. Because H₂ is produced in the exhaust gas recirculation system 12, any engine 10 producing CO and H₂O can beneficially make use of the present invention. Generally, an engine produces more CO and H₂O with air/fuel ratios at, or richer than, a stoichiometric mixture.

Turning now to the illustrated embodiment represented in FIGS. 1 and 2, the forced induction, fuel-injected engine 10 has an intake duct 14 through which intake air is drawn and subsequently inducted into an intake manifold 16 and then into a plurality of combustion chambers 18 by a compressor stage 20 of a turbocharger 22. In the embodiment illustrated in FIG. 1, intake air discharged from the compressor 20 is directed through a heat exchanger 24, sometimes also referred to as an intercooler or a charge cooler, by which the intake air and recirculated exhaust gas charge is cooled prior to introduction into the intake manifold 16 and subsequently into the combustion chambers 18. Fuel is introduced by way of a fuel injection system, represented by a fuel line 26, which controllably injects fuel through injection nozzles 27 directly into respective combustion chambers 18. Alternatively, the fuel injectors 27 may be positioned in the intake port of, or in otherwise close proximity to, a respective combustion chamber 18.

After combustion of the fuel in the combustion chambers 18, the products of combustion are discharged into an exhaust manifold 28. The exhaust gas is then directed through a turbine stage 30 of the turbo charger 22 into an exhaust duct 32. Typically, the engine may also have a three-way catalyst 34, and/or other exhaust gas aftertreatment devices, as illustrated in FIG. 1, through which exhaust gas passes prior to discharge into the ambient environment.

For purposes of carrying out the method embodying the present invention, the engine 10 uses the water gas shift catalyst 38 in the exhaust gas recirculation system 12 to increase the hydrogen content in the EGR. More specifically, a portion of the exhaust gas passing through the exhaust manifold 28 is directed through the exhaust duct 32 to an exhaust gas recirculation flow control valve 36, which regulates the relative portion of the exhaust gas directed through the EGR system 12. Importantly, after passing through the EGR flow control valve 36, the recirculated exhaust gas is directed through an exhaust gas recirculation water-gas shift catalyst 38 in which a water-gas shift reaction takes place, resulting in an increase in the hydrogen content of the gas. After passing from an outlet 40 of the water-gas shift catalyst, the hydrogen-enriched exhaust gas, along with ambient air, is directed into an inlet 42 of the compressor 20 where it is compressed and subsequently discharged from an outlet 44 of the compressor to an inlet 46 of the heat exchanger 24. After being cooled in the heat exchanger 24, the ambient air/hydrogen enriched recirculated exhaust gas is directed through an outlet 48 of the heat exchanger into the intake manifold 16 and then into respective combustion chambers 18 of the engine 10.

Various catalysts suitable for use in the water-gas shift reaction, incorporated in the exhaust gas recirculation system 12 of the present invention, are described in the above-discussed U.S. Pat. No. 5,339,634 granted to Gale et al. and in U.S. Pat. No. 6,713,040 B2 granted Mar. 30, 2004 to ShabbirAhmed, et al. for a METHOD FOR GENERATING HYDROGEN FOR FUEL CELLS.

As noted above, CO and H₂O are necessary constituents of the exhaust gas stream in order to promote the water-gas shift reaction. The relative amounts of CO and H₂O in an exhaust gas stream are strongly dependent upon the air/fuel ratio of the combusted air/fuel charge. Greater amounts of CO and H₂O will be generated if the air/fuel ratio is rich of stoichiometric, i.e., having an equivalence ratio greater than 1. Thus, in the first preferred embodiment illustrated in FIGS. 1 and 2, the engine is desirably operated with an air/fuel ratio that is at stoichiometric or richer to provide significant amounts of CO and H₂O in the recirculated exhaust gas.

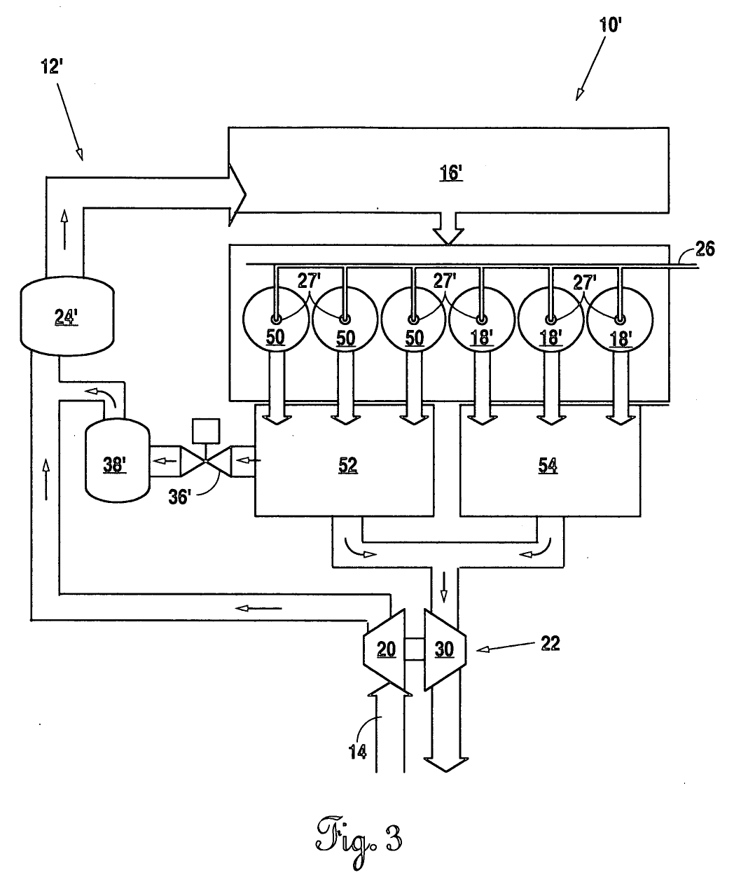

However, many fuel-injected engines are designed, for purposes of efficiency and emissions control, to operate in a lean-burn combustion mode, i.e., with an air/fuel equivalence ratio less than 1, in which relatively lesser amounts of CO and H₂O are available. A second embodiment of the present invention, in which a forced induction fuel-injected engine 10′ designed for lean-burn operation, is illustrated in FIG. 3. In this embodiment, a low pressure exhaust gas recirculation system 12′ is in fluid communication with only a predetermined portion of the combustion chambers, respectively identified by reference number 50. The number of designated combustion chambers 50 from which exhaust gas is recirculated may be only a single combustion chamber or three chambers as illustrated in FIG. 3. The number of combustion chambers 50 associated with the exhaust gas recirculation system 12′ will depend on the exhaust gas recirculation requirements of an engine. Importantly, the designated combustion chambers 50 can be operated in a rich, or slightly rich, combustion mode while operating the remaining cylinders 18′ in a lean-burn combustion mode.

The products of rich, or slightly rich, combustion are directed from the combustion chambers 50 through a first exhaust manifold 52 and thence through an exhaust gas recirculation flow control valve 36′ to an EGR water-gas shift catalyst 38′. After passing through the water-gas shift catalyst 38′, the hydrogen-enriched exhaust gas is directed, along with compressed inlet air discharged from the compressor 20, through the heat exchanger 24′ into the intake manifold 16′ and then into respective combustion chambers 18′, 50. The non-designated combustion chambers 18′ are in fluid communication with a second exhaust manifold 54 and are not part of the exhaust gas recirculation system 12′.

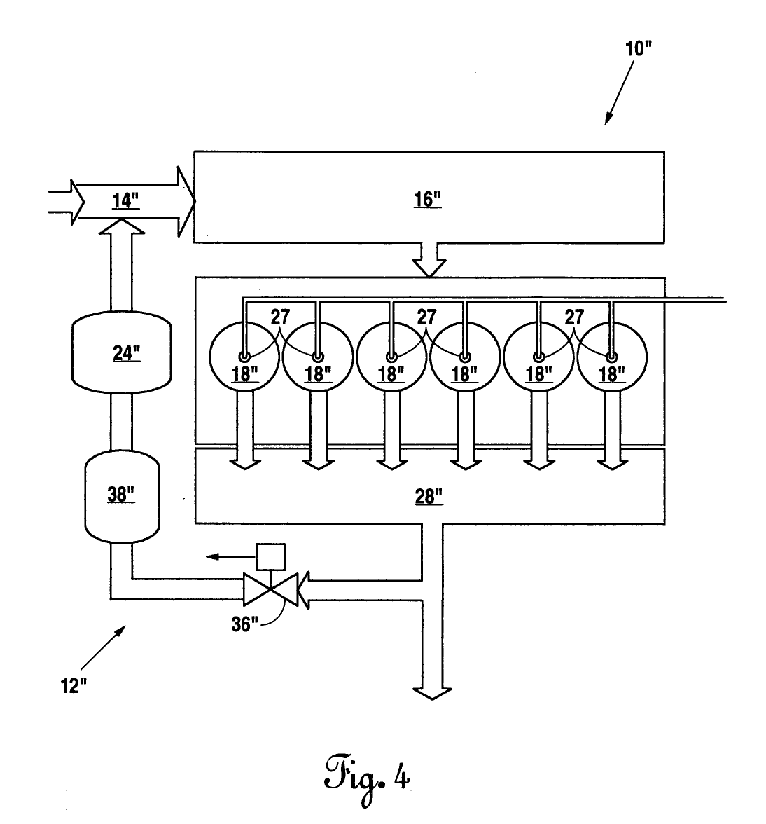

In a third embodiment of the present invention, a naturally-aspirated fuel-injected engine 10″ is schematically illustrated in FIG. 4. In this embodiment, exhaust gas is discharged from an exhaust manifold 28″ and a portion, controlled by an exhaust gas recirculation control valve 36″, is directed through a water-gas shift catalyst 38″ where the water-gas shift reaction increases the hydrogen content of the recirculated exhaust gas. The hydrogen-enriched exhaust gas is then passed through a heat exchanger 24″ and cooled prior to mixing with intake air in an intake duct 14″. The mixture of hydrogen-enriched exhaust gas and intake-air is directed into an intake manifold 16″ and subsequently inducted into the combustion chambers 18″. Alternatively, only the exhaust gas from one or more designated combustion chambers may be recirculated using separate exhaust manifolds as illustrated in FIG. 3.

Importantly, the hydrogen enrichment of recirculated exhaust gas in accordance with the present invention does not impair the performance of downstream exhaust gas aftertreatment systems, such as three-way catalysts. Also, fuel injection enables precise air/fuel ratio control to regulate the recirculated water-gas shift reaction using global air/fuel ratio control, as illustrated in FIGS. 1, 2 and 4, or individual cylinder air/fuel ratio control, as illustrated in FIG. 3. Advantageously, fuel injection enables a portion of the combustion chambers of an engine to be operated at an equivalence ratio just rich of stoichiometric, for example about 1.05, thereby enabling the production of significant amounts of H₂ through the water-gas shift reaction. In such an arrangement, the exhaust from the combustion chambers operating just rich of stoichiometric are used as the recirculated exhaust gas for all combustion chambers. It should also be recognized that minor deviations in global air/fuel ratio control, and subsequent hydrogen production, could also be used to assist qualitative engine performance characteristics, such as drivability and transient response with little penalty on thermal efficiency.

From the above description, it can be seen that the present invention uses a water-gas shift catalyst to generate an intake charge composition for fuel-injected engines that can beneficially increase knock resistance and engine exhaust gas recirculation tolerance. Furthermore, the use of the water-gas shift reaction in the recirculated exhaust gas provides an intake air/hydrogen-enriched recirculated exhaust gas composition that increases the ignitability, flammability, and flame speed of the intake charge in fuel-injected engines. Advantageously, the water-gas shift reaction in the recirculated exhaust gas simultaneously decreases the CO and H₂O in the exhaust gas while increasing the more benign CO₂ content of the engine exhaust.

Although the present invention is described in terms of preferred illustrated embodiments, those skilled in the art will recognize that the use of a water-gas shift catalyst in the recirculated exhaust gas stream of a fuel-injected engine can be carried out using different air/fuel ratio strategies and exhaust gas recirculation system arrangements than those specifically described. For example, the exhaust gas recirculation valve may be a three-way valve disposed directly in the exhaust duct with a first outlet port from which exhaust gas is discharged into the ambient environment and a second outlet port through which exhaust gas is directed to the EGR system. Such arrangements of the apparatus and applications of the method embodying the present invention are intended to fall within the scope of the following claims.

Other aspects, features, and advantages of the present invention may be obtained from a study of this disclosure and the drawings, along with the appended claims.

What we claim is:

1. An apparatus for increasing the amount of hydrogen in the recirculated exhaust gas of a fuel-injected engine having a plurality of combustion chambers, an intake manifold in fluid communication with said plurality of combustion chambers, and an exhaust manifold in fluid communication with at least one of said combustion chambers, comprising:
a fuel injection system adapted to inject controlled amounts of fuel into each of said combustion chambers;
an exhaust gas recirculation system having an inlet in controlled fluid communication with said exhaust manifold and an outlet in fluid communication with said intake manifold;
a water-gas shift catalyst disposed in said exhaust gas recirculation system and having an inlet and an outlet; and
an exhaust gas recirculation flow control valve disposed at a position sufficient to control the flow of exhaust gas through said exhaust gas recirculation system and having an inlet in fluid communication with said exhaust manifold of the engine and an outlet in fluid communication with the inlet of said water-gas shift catalyst.

2. The apparatus for increasing the amount of hydrogen in the recirculated exhaust gas of a fuel-injected engine, as set forth in claim 1, wherein said apparatus includes a compressor having an inlet in fluid communication with a source of ambient air and an outlet in fluid communication with said intake manifold.

3. The apparatus for increasing the amount of hydrogen in the recirculated exhaust gas of a fuel-injected engine, as set forth in claim 2, wherein the outlet of said water-gas shift catalyst is in fluid communication with the inlet of said compressor.

4. The apparatus for increasing the amount of hydrogen in the recirculated exhaust gas of a fuel-injected engine, as set forth in claim 2, wherein said exhaust gas recirculation system includes a heat exchanger having an inlet in fluid communication with the outlet of said compressor and an outlet in fluid communication with said intake manifold.

5. The apparatus for increasing the amount of hydrogen in the recirculated exhaust gas of a fuel-injected engine, as set forth in claim 4, wherein the outlet of said water-gas shift catalyst is in direct fluid communication with the inlet of said heat exchanger.

6. A method for increasing the amount of hydrogen in the recirculated exhaust gas of a fuel-injected engine having a plurality of combustion chambers, an intake manifold in fluid communication with said plurality of combustion chambers, and an exhaust manifold in fluid communication with at least one of said combustion chambers, comprising:
providing an exhaust gas recirculation system having an inlet in fluid communication with said exhaust manifold and an outlet in fluid communication with said intake manifold;
disposing a water-gas shift catalyst in said exhaust gas recirculation system;
inducting a mixture of recirculated exhaust gas and ambient air into the combustion chambers of said engine;
controllably injecting fuel into the combustion chambers of said engine, combusting the fuel, and producing an exhaust gas;
controllably circulating at least a portion of said exhaust gas through the water-gas shift catalyst disposed in said exhaust gas recirculaton system and forming a hydrogen enriched exhaust gas; and
directing said hydrogen enriched exhaust gas into said intake manifold of the engine.

7. The method for increasing the amount of hydrogen in the recirculated exhaust gas of a fuel-injected engine as set forth in claim 6, wherein said exhaust gas recirculation system includes an exhaust gas flow control valve and said controllably circulating at least a portion of said exhaust gas through the water-gas shift catalyst includes modulating said exhaust gas flow control valve.

8. The method for increasing the amount of hydrogen in the recirculated exhaust gas of an engine, as set forth in claim 6, wherein said engine has a first exhaust manifold in fluid communication with at least one of said combustion chambers and a second exhaust gas manifold in fluid communication with other ones of.said plurality of combustion chambers, said inlet of the exhaust gas recirculation system being in fluid communication only with said first exhaust manifold, and said controllably circulating at least a portion of said exhaust gas through the water-gas shift catalyst includes controllably only circulating at least a portion of the exhaust gas from said first exhaust manifold through the water-gas shift catalyst.

9. The method for increasing the amount of hydrogen in the recirculated exhaust gas of an engine, as set forth in claim 6, wherein said exhaust gas recirculation system includes a heat exchanger and said controllably circulating at least a portion of said exhaust gas through the water-gas shift catalyst disposed in said exhaust gas recirculaton system and forming a hydrogen enriched exhaust gas includes passing said hydrogen enriched exhaust gas through said heat exchanger prior to directing the hydrogen enriched exhaust gas into the intake manifold of the engine.
